(19) United States
(12) Patent Application Publication
(10) Pub. No.: US 2005/0165155 A1
(43) Pub. Date: Jul. 28, 2005

(54) Insulating polymers containing polyaniline and carbon nanotubes

(76) Inventor: Graciela Beatriz Blanchet-Fincher, Greenville, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/969,422

(22) Filed: Oct. 20, 2004

Related U.S. Application Data
(60) Provisional application No. 60/513,352, filed on Oct. 21, 2003.

(51) Int. Cl. C08J 3/00

(52) U.S. Cl. 524/498

(57) ABSTRACT

The present invention is a composition comprising carbon nanotubes and conductive polyaniline in an insulating polymer matrix and a process for making that composition.

### FIELD OF THE INVENTION

The present invention relates to a composition comprising carbon nanotubes and conductive polyaniline in a matrix of insulating polymer and a process for making said composition. It has been found that first treating nanotubes with a polyaniline solution permits the use of a reduced quantity of nanotubes, in situations where the nanotubes are used to increase electrical conductivity.

### TECHNICAL BACKGROUND

Over the last 30 years there has been considerable interest in developing polymers with conductive rather than insulating properties, such that they could be used in active electronic devices.

Tailoring electrical properties of polymers has been achieved utilizing three different strategies:
1) Modifying the intrinsic bulk properties by altering the chemical composition and structure of the starting material
2) Altering the properties of the polymer at the molecular level incorporating dopants, which may form charge transfer complexes with the host polymer. This approach is molecular doping in which molecules such as AsF₅ and I₂ are incorporated into polymers such as polyactelyne and polycarbonate, and
3) The most commonly utilized strategy is the attainment of the desired conductivity by incorporating microscopic pieces such as metal flakes, carbon-black particulate into the host polymer to form conducting polymers.

Although route (2) provides the most efficient pathways to polymeric synthetic metals, some materials tend to exhibit lack of stability under ambient conditions.

Alternatively more modest conductivity values (0.001 S/cm) can be achieved by filling inert polymers with conductors. Conductivities of 10⁻¹⁰ to 10⁻¹ S/cm are readily achieved and can be tailor into the specifications. The electrical conductivity depends upon filler loading and there is a steep dependence of conductivity on filler load over a short filler concentration range above a critical level (percolation threshold). Since high levels of filler loading 10-40% are employed to achieve high conductivities, polymer processability is severely hindered.

In contrast, typical synthetic metals such as polyacetylene, polyphenylene, and polyphenylene sulfide, can exhibit conductivities in the 10²-10³ s/cm range in a metallic regime. However, since these values are obtained via strong oxidizing or reducing reaction materials tend to be unstable at ambient conditions limiting practical applications.

Organic conductors such as polyacetylene, which have a π-electron system in their backbone or like poly-(p-phenylene), and polypyrole consist of a sequence of aromatic rings and are excellent insulators in native state and can be transformed into complexes with metallic conductivity upon oxidation or reduction. In particular, the electrical conductivity of polyacetylene (CH)ₓ increases by a factor of 10¹¹ when the polymer is doped with donor or acceptor molecules. Over the last 30 years there has been considerable interest in developing polymers with conductive rather than insulating properties such that they could be used in active electronic devices.

Tailoring electrical properties of polymers has been achieved utilizing three different strategies:
(1) Modifying the intrinsic bulk properties by altering the chemical composition and structure of the starting material
(2) Altering the properties of the polymer at the molecular level incorporating dopants, which may form charge transfer complexes with the host polymer. This approach is molecular doping in which molecules such as AsF₅ and I₂ are incorporated into polymers such as polyactelyne and polycarbonate, and
(3) The most commonly utilized strategy is the attainment of the desired conductivity by incorporating microscopic pieces such as metal flakes, carbon-black particulate into the host polymer to form conducting polymers.

Although route (2) clearly provides the most efficient pathways to polymeric synthetic metals, materials tend to exhibit lack of stability under ambient conditions. In the case of polyacetylene, poly(1,6-heptadiyne) and polypropyne the un-doped polymers are unstable in oxygen. Although poly-p-phenylene, poly-p-phenylene oxide and poly-p-phenylene sulfide are stable in oxygen they can only be doped with powerful acceptors such as AsF₅and once doped they are susceptible to rapid hydrolysis under ambient conditions. Although polypyrole is stable under ambient conditions it lacks some of the other desirable characteristics, most notably variable conductivity.

Alternatively more modest conductivity values (0.001 S/cm) can be achieved by filling inert polymers with conductors. Conductivities of 10⁻¹⁰ to 10⁻¹ S/cm are readily achieved and can be tailor into the specifications. The electrical conductivity depends upon filler loading and there is a steep dependence of conductivity on filler load over a short filler concentration range above a critical level (percolation threshold). Since high levels of filler loading 10-40% are employed to achieve high conductivities, polymer processability is severely hindered. Typical fillers are PAN-derived C fibers, metallized glass fibers, Al flakes, Al rods and carbon black. Typical 20 loading and resulting conductivivities are shown in the table below:

| Composite | Conductivity (S/cm) |
|---|---|
| Polycarbonate (PC) | 10⁻¹⁶ |
| PC + 20% Al flake | 10⁻¹⁵ |
| PC + 30% Al flake | 1 |
| PC + 10% PAN carbon | 10⁻⁸ |
| fiber | |
| PC + 40% PAN C fibers | 10⁻² |
| Nylon 6,6 (N-6,6) | 10⁻¹⁴ |
| N-6,6 + 40% pitch C fiber | 10⁻⁴ |
| N-6,6 + 40% PAN C fiber | 1 |

In contrast, typical synthetic metals such as polyacetylene, polyphenylene, and polyphenylene sulfide, can exhibit conductivities in the 10²-10³ s/cm range in the metallic regime. However, since these values are obtained via strong oxidizing or reducing reaction materials tend to be not stable at ambient conditions limiting practical applications.

The search for environmentally stable synthetic metals led to considerable effort in polyanilines (PANI). Although these materials have lower conductivity in the metallic state they appear to also have significant IT de-localization in the polymer backbone but unlike other conducting polymers they are stable in air indefinitely. In particular the emeraldine base form of polyaniline can be doped to the metallic conducting regime by dilute non-oxidizing aqueous acids such as HCl to yield an emeraldine salt that exhibits metallic conductivity but is air stable and cheap to produce in large quantities. The emeraldine form of polyaniline is believed to show high conductivity because of the extensive conjugation of the backbone. Unlike all other conjugated polymers the conductivity of the material depends on two variables rather than one, namely the degree of oxidation of the PANI and the degree of protonation. The highest conductivity PANI's are those cast from solutions of PANI camphosulfonate (PANI-CSA) in m-cresol ˜10² S/cm about two order of magnitude higher than PANI's protonated with mineral acids which range from 10⁻¹ to 10¹ S/cm.

Achieving stable polymeric materials with metallic conductivities that are processable and stable at ambient conditions is important for further enabling the use of conducting polymers in electronic applications. It has been previously shown that small amounts of carbon nanotubes increase the conductivity of PANI by 4-5 orders of magnitude. Since the nanotube concentration is considerably lower than that required of fillers, the processability of the host polymer can be maintained while the conductivity is increased. However, the printable formulations developed had some disadvantages as well. For example in printing applications where resolution of the transfer film is important, only a few doped polyanilines were useful. In addition, when multi-layer TFT structures are built adhesion between the sequential layers of an electronic device is crucial. In particular, for TFT applications the adhesion of the transfer PANI composite to the gate dielectric was difficult. In addition, when doped-PANI represents the bulk of a film, the amount of acid is considerable. Migration of acid when under an electric filed would lead to the doping of the semiconducting and performance degradation. In this application it is shown that if carbon nanotubes are coated with polyaniline prior to their incorporation into an insulating matrix their electrical behavior remains unchanged relative to that observed when tubes were incorporated in a doped-pani conducting matrix. This provides several advantages relative to the SWNT/PANI compositions disclosed previously. One can print a TFT using the similar binder material for the conducting and insulating layers. One can adjust the adhesion of sequential layers with the glass transition of a family of polymer. The amount of PANI is the formulation is minimal since PANI is only the “glue” connecting the tubes. Thus, the possibility of acid migration is not only lower but it would only migrate to the surrounding insulating matrix.

Niu (U.S. Pat. No. 6,205,016) describes composite electrodes including carbon nanofibers and an electrochemically active material for use in electrochemical capacitors.

Kenny (U.S. Pat. No. 5,932,643) describes coating formulations for printed images, which contain conductive polymers.

U.S. Ser. No. 02/05486 application describes a composition comprising conductive polyaniline and carbon nanotubes.

U.S. Ser. No. 03/05771 application describes composition comprising conductive polyaniline and carbon nanotubes for laser printing.

In contrast, the present invention is a composition comprising carbon nanotubes dispersed with conductive polyaniline in an insulating polymer matrix. The dispersion of polyaniline with the carbon nanotubes allows percolation and hence metallic-like values of the electrical conductivity at lower volume fractions of carbon nanotubes than if the nanotubes had not been dispersed with the polyaniline. The present invention is also a process for making the above-described composition.

### SUMMARY OF THE INVENTION

This invention describes a composition comprising:
a) An insulating polymer matrix
b) 0.1 to 10% by weight of carbon nanutubes dispersed in said insulating polymer matrix
c) conductive polyaniline dispersed with said carbon nanotubes.

The invention is also a process comprising:
a) dispersing carbon nanotubes in a solvent also containing dissolved polyaniline to form a first liquid dispersion
b) adding a solution of insulating polymer to said first liquid dispersion to form a second liquid dispersion
c) depositing said second liquid dispersion on a substrate and allowing said solvent to evaporate.

### BRIEF DESCRIPTION OF THE DRAWINGS

FIG. 1 is a graph of conductivity over the %SWNT.

FIG. 2 is a graph describing conductivity, DNNSA-Pani, SWNT/EC over %SWNT.

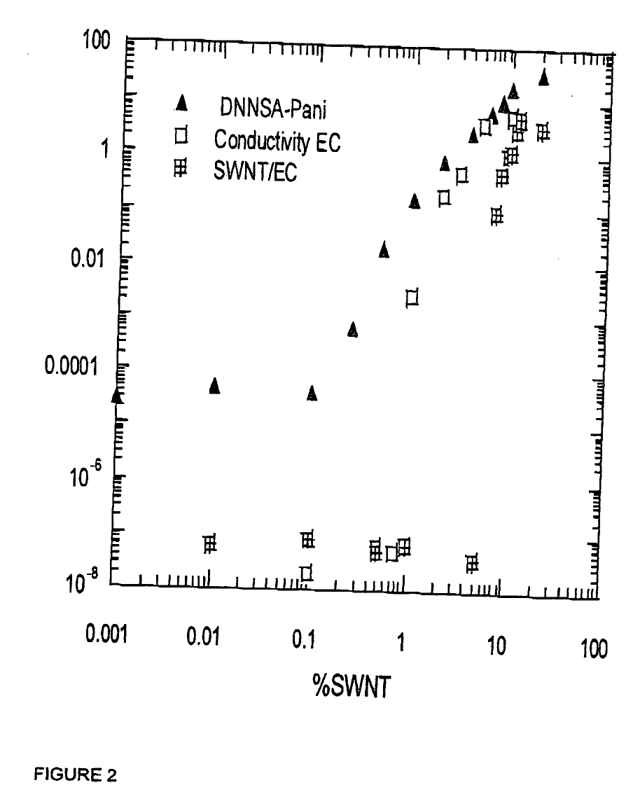

FIG. 3 is a graph of conductivity over %SWNT.

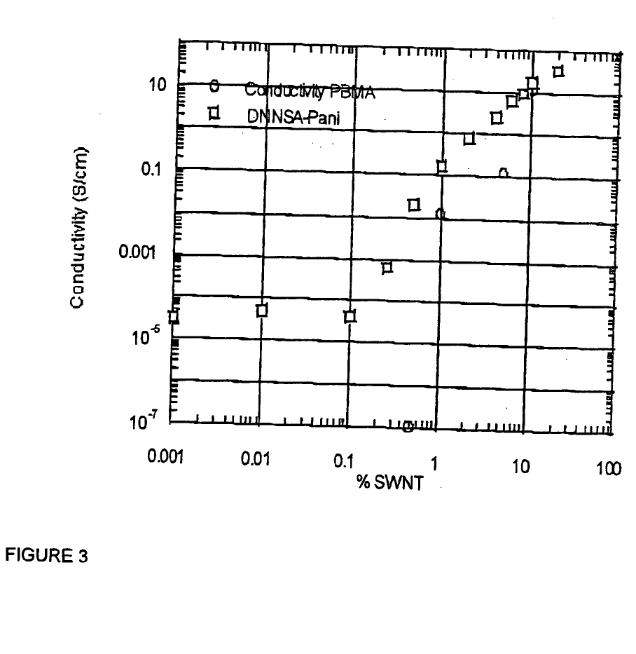

FIG. 4 is a graph of resistivity (ohm-square) over % filler.

### DETAILED DESCRIPTION OF THE INVENTION

It is shown here that small amounts of nanotubes dispersed with polyaniline (PANI) in an insulating matrix provide a path to high conductivity while retaining the very low percolating threshold achieved for nanotubes in a conducting matrix. In particular, incorporating nanotubes dispersed with PANI in materials that are good gate dielectrics results in a material of conductivity appropriate for applications in microelectronics; i.e. such as gates, sources, drains and interconnects in plastic thin film transistors (TFT). These materials are compatible with the processes for fabrication of all layers of a TFT, in particular, the gate dielectric.

The present invention is a composition comprising an insulating polymer matrix of materials such as, but not limited to, polystrene, ethylcellulose, Novlac TM (DuPont, Wilmington, Del.), poly hydroxy sytrene and its copolymers, poly methyl methacrylates and its copolymers and poly-ethyl methacrylate. Within the insulating polymer matrix is dispersed a mixture of carbon nanotubes and conductive polyaniline. The mixture of carbon nanotubes and conductive polyaniline is produced by dispersing carbon nanotubes in xylenes and then adding doped polyaniline (doped with, for example, di-nonyl naphthalene sulfonic acid, benzyl sulfonic acid or camphor sulfonic acid to make the polyaniline conductive) to the dispersion. The polyaniline is added as a solution of polyaniline in xylenes. A solution of insulating polymer is then added to the dispersion. When this dispersion is deposited on a substrate and the solvent is allowed to evaporate, the deposit comprises the composition of the present invention, an insulating polymer matrix containing a dispersion of carbon nanotubes and doped polyaniline. The amounts of nanotubes and polyaniline dispersed in the insulating polymer matrix can be varied by varying the ratios of the various components in the xylenes. A level of 0.25% by weight of carbon nanotubes is required to achieve percolation and obtain metallic conductivity. The present invention also comprises the process to obtain this composition as described above.

The substrate for deposition of insulating polymer solution mixed with the polyaniline/carbon nanotube dispersion can be a donor element for thermal transfer printing. For example, a transparent substrate such as MYLAR TM (Dupont, Wilmington, Del.) can be used. After deposition of the dispersion, the solvent is allowed to evaporate. The donor element is positioned over a receiver element, which is to be patterned with the material to be transferred. A pattern of laser radiation is exposed to the donor element such that a pattern of the dried dispersion is transferred to the receiver.

Alternatively, the insulating polymer solution mixed with the polyaniline/carbon nanotube dispersion can be patterned by a printing process such as ink jet printing, flexography or gravure prior to the evaporation of the solvent. The dispersion is patterned on to a substrate and then the solvent is allowed to evaporate.

### EXAMPLES

### Examples 1-2

This example shows the effect on conductivity of adding carbon nanotubes coated with DNNSA-PANI and incorporated the PANI coated tubes into an insulated matrix. The conductivity of carbon nanotubes in a conducting DNNSA-PANI matrix is also included for comparison. (Di-nonyl naphthalene sulfonic acid is “DNNSA” herein). The polyaniline was protonated as reported in U.S. Pat. No. 5,863,465 (1999) (Monsanto patent) using di-nonyl naphthalene sulfonic acid. DNNSA-PANI with (single walled nano-tube) SWNT dispersions were created by using a total of 2.5% solids in xylenes with 20% of the solids being Hipco single wall carbon nanotubes (CNI incorporated, Houston Tex.) and 80% of the solids from DNNSA-PANI solution in xylenes with 34% solids. The composite was made following the following procedure:
The CNT were 1st dispersed into the xylenes using 10 minutes horn sonication at ambient temperature.
The DNNSA-PANI was dispersed into the CNT/xylenes solution using 5 minutes horn sonication at ambient temperature using a 4:1 PANI/SWNT ratio as specified above.
The insulator solution comprised 10% by weight polystyrene (Aldrich) in xylenes.

PAni/Hipco dispersions were dispersed in the Polystyrene solutions at 0.1, 0.2, 0.3, 0.4, 0.5, 1, 2, 3, 5, 10% NT concentration. The solution was then coated onto glass slides with Ag contacts and their conductivity measured.

The Ag contacts were sputtered onto 2″×3″ microscope slides to 2000 Å in thickness through an aluminum mask using a Denton vacuum unit (Denton Inc. Cherry Hill, N.J.). Films were coated onto the microscope slides with Ag contacts using a #4 Meyer rod and dried in a vacuum oven at 60° C. for 45 seconds. The coated area was 1″×2″ and the film thickness around 1 microns. Thicknesses were determined by profilometry. The film conductivity was measured using the standard 4-probe measurement technique. The current was measured at the two outer contacts. These contacts were separated by 1″ and connected to a Hewlett Packard power supply in series with an electrometer (Keithley, 617). The voltage was measured at the two inner contacts, separated 0.25″ using a Keithley multimeter. The resistivity (in ohm-square) as a function of nanotube concentration is shown in the figure below. The conductivity p was calculated as: μ=i Id/VA (1)

Where V is the voltage measured at the outer contacts and i the current at the 2 inside contacts, I the separation between the inner contacts and A the area of the film and d is the film thickness.

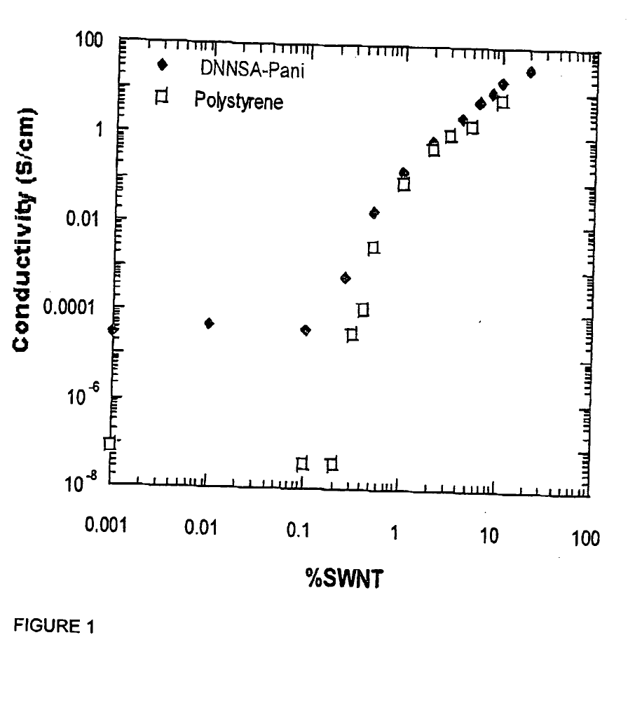

The curves in FIG. 1 show the conductivity of DNNSA-PANI as a function of SWNT concentration and the conductivity of the DNNSA-PANI coated SWNT in a polystyrene matrix as a function of the concentration of SWNT. As shown in the figure both composites percolate at ˜0.25% by weight nanotube concentration and being in a conducting or insulating matrix does not seem to make a difference at concentrations of 1% and above.

### Examples 3-5

Example 3 shows the effect on conductivity of adding carbon nanotubes coated with DNNSA-PANI and incorporated the PANI coated tubes into an ethyl cellulose insulating matrix (example 4) relative to a DNNSA-PANI insulating matrix (example 3). The data in example 5 shows the conductivity of bare SWNT's dispersed in an ethyl cellulose matrix. As in examples 1-2, the polyaniline was protonated as reported in U.S. Pat. No. 5,863,465 (1999) (Monsanto patent) using di-nonyl naphthalene sulfonic acid. The DNNSA-PANI/SWNT dispersions were created by using a total of 2.5% solids in xylenes with 20% of the solids being Hipco (R0236) Carbon Nanotubes (CNI incorporated, Houston Tex.) and 80% of the solids from DNNSA-PANI solution in xylenes with 34% solids. The composite was made following the procedure described in the previous example. PAni/Hipco dispersions were dispersed in the Polystyrene solutions at 0.1, 0.2, 0.3, 0.4, 0.5, 1, 2, 3, 5, 10% NT concentration. Prior to the coating of the film, Ag contacts were sputtered onto 2″×3″ microscope slides to 2000 Å in thickness through an aluminum mask using a Denton vacuum unit (Denton Inc. Cherry Hill, N.J.). Films were coated onto the microscope slides with Ag contacts using a #4 Meyer rod and dried in a vacuum oven at 60° C. for 45 seconds. The coated area was 1″×2″ and the film thickness around 1 microns. Thicknesses were determined by an optical interferometer. Hipco dispersions in Ethylcellulose at 0.1, 0.5, 1, 5, 7, 9, 10, 20% NT concentration were made. 1-minute horn sonication was used to disperse the NT.

PAni/Hipco dispersions in Ethylcellulose (126-1) solution@0.1, 0.5, 0.75, 1, 2, 3, 5, 10% NT concentration were made.

### Example 6

Example 6 shows the effect on conductivity of adding carbon nanotubes coated with DNNSA-PANI into a poly-ethyl methacrylate matrix (example 6) relative to a DNNSA-PANI insulating matrix (example 3). The data in example 6 shows the conductivity of PANI coated SWNT's dispersed in an poly ethyl methacrylate matrix. As in examples 1-2, the polyaniline was protonated as reported in U.S. Pat. No. 5,863,465 (1999) (Monsanto patent) using di-nonyl naphthalene sulfonic acid. The DNNSA-PANI/SWNT dispersions were created by using a total of 2.5% solids in xylenes with 20% of the solids being Hipco (R0236) Carbon Nanotubes (CNI incorporated, Houston Tex.) and 80% of the solids from DNNSA-PANI solution in xylenes with 34% solids. The composite was made following the procedure described in the previous example.

PAni/Hipco dispersions were dispersed in the Polystyrene solutions at 0.1, 0.5,1, 5, 10% NT concentration. Prior to the coating of the film, Ag contacts were sputtered onto 2″×3″ microscope slides to 2000 Å in thickness through an aluminum mask using a Denton vacuum unit (Denton Inc. Cherry Hill, N.J.). Films were coated onto the microscope slides with Ag contacts using a #4 Meyer rod and dried in a vacuum oven at 60° C. for 45 seconds. The coated area was 1″×2″ and the film thickness around 1 microns. Thickness' were determined by an optical interferometer.

### Example 7-9

Example 7 illustrates the advantage of using nanotubes to increase the conductivity of PANI relative to the use of carbon black ink and conducting Ag ink as fillers.

A 2.60 W. % conductive polyaniline in xylenes was made by adding 14.36 g xylenes (EM Science, purity:98.5%) to 0.9624 g XICP-OSO1, a developmental conductive polyaniline solution from Monsanto Company. XICP-OSO1 contains approximately 48.16 W. % xylenes, 12.62 W. % butyl cellosolve, and 41.4 W. % conductive polyaniline.

Nanotubes were dispersed in turpinol at 1.43% by weight. The nanotube/turpinol mixture was sonicated for 24 hours at ambient temperature prior to mixing with the 41.4% solution of PANI- XICP-OSO1. The nanotube/PANI solutions at 0, 0.25, 0.5, 0.75, 1, 1.25, 1.5, 1.75, 2, 4, 6, 10, 20 and 40% nanotube concentration were coated onto microscope slides and dried in a vacuum oven at 60° C. for 30 seconds.

In example 8, PANI-XICP-OSO1 was mixed with Graphitic ink PM-003A (Acheson colloids, Port Hurom, Mich.) at 0, 5, 10, 20, 40 and 100% by weight.

In example 9, PANI-XICP-OSO1 was mixed with Ag conducting ink #41823 (Alfa-Aesar, Ward Hill, Mass.) at 0, 5, 10, 20, 40, 80 and 100% by weight.

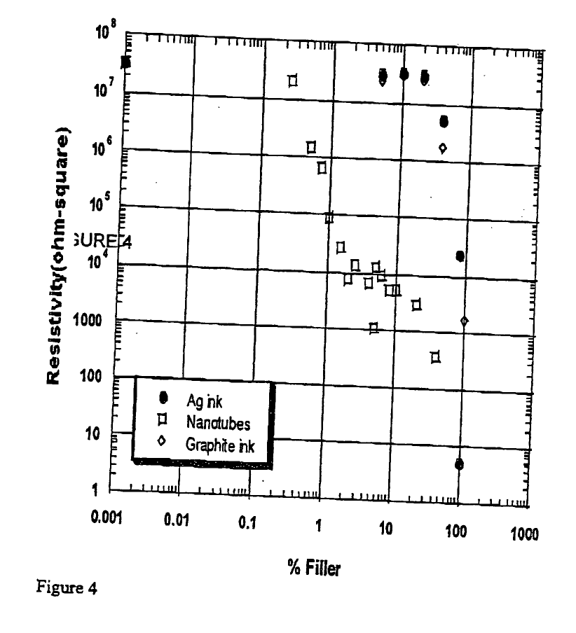

The coated area was 1″×2″. Film thickness was determined by optical interferometry. The Ag contacts for resistivity measurements were sputtered to 4000 Å in thickness through an aluminum mask using a Denton vacuum unit (Denton Inc. Cherry Hill, N.J.). The film resistivity was measured using the standard 4-probe measurement technique. The current was measured at the two outer contacts. These contacts were separated by 1″ and connected to a Hewlett Packard power supply in series with an electrometer (Keithley, 617). The voltage was measured at the two inner contacts, separated 0.25″ using a Keithley multimeter. The resistivity (in ohm-square) as a function of nanotube, graphitic ink and Ag ink concentrations are shown in the figure below. As shown in FIG. 4 below the resistivity of the film decreases by 4 orders of magnitude with only 2% loading of nanotubes while it does not change with less than 20% loading of a conducting graphitic or Ag inks.

1. A composition comprising:
a) An insulating polymer matrix
b) 0.1 to 10% by weight of carbon nanutubes dispersed in said insulating polymer matrix
c) conductive polyaniline coated on said carbon nanotubes

2. A process comprising:
a) dispersing carbon nanotubes in a solvent also containing dissolved polyaniline to form a first liquid dispersion
b) mixing a solution of insulating polymer with said first liquid dispersion to form a second liquid dispersion depositing said second liquid dispersion on a substrate and allowing said solvent to evaporate.

3. The process of claim 2 wherein said substrate is a donor element for thermal transfer printing.

4. The process of claim 2 wherein the depositing of said second liquid dispersion on a substrate is accomplished by a printing method selected from the group consisting of ink jet printing, flexography and gravure.
